(19) United States
(12) Patent Application Publication
(10) Pub. No.: US 2018/0130302 A1
(43) Pub. Date: May 10, 2018

(54) LAST MAN STANDING SPORTING EVENT WAGERING PLATFORM

(71) Applicant: Metric Gaming LLC, Las Vegas, NV (US)

(72) Inventor: Martin De Knijff, Las Vegas, NV (US)

(21) Appl. No.: 15/570,138

(22) PCT Filed: Apr. 28, 2016
(86) PCT No.: PCT/US16/29764

§ 371 Date: Oct. 27, 2017

Related U.S. Application Data
(60) Provisional application No. 62/154,257, filed on Apr. 29, 2015.

(51) Int. Cl. G07F 17/32

(52) U.S. Cl. CPC G07F 17/3262; G07F 17/3276; G07F 17/3223; G07F 17/3288; G07F 17/3269

(57) ABSTRACT

A system, a method, a device, a platform, and a computer program product for wagering are disclosed. Participants are allowed to wager on an event such as a sporting or entertainment event. The participants select from a plurality of defined actions, which participants predict will occur in the event after a specified time. Those participants who successfully selected the correct action can advance to the next round, while the others are eliminated. The process can be repeated until one participant remains.

### CROSS-REFERENCE TO RELATED APPLICATIONS

The present application claims priority to U.S. Provisional Patent Application No. 62/154,257 to Martin De Knijff, filed Apr. 29, 2015, and entitled “Last Man Standing Sporting Event Wagering Platform”, and incorporates its disclosure herein by reference in their entirety.

### TECHNICAL FIELD

In some implementations, the current subject matter generally relates to a wagering platform for an event, such as a sporting and/or entertainment event and/or any other event/occurrence, to facilitate, for example, additional enjoyment and/or participation during the event.

### BACKGROUND

Traditional wagering platforms allow participants to wager on the outcome of a sporting event or other aspect of a final result (e.g., winner/loser and over/under). Further, such platforms typically only require a single action by its participants, such as prior to the start of the event, instead of an interactive participation.

### SUMMARY

In some implementations, the current subject matter provides an interactive wagering platform, including a tournament in which participants can try to predict one or more defined actions that occur during an event. If a participant successfully predicts an action, the participant can continue in the tournament to predict the next action. If a participant's prediction is incorrect, the participant can be dropped from the tournament and prevented from further participation. Predictions can continue until, for example, only one successful participant is left in the tournament. In some implementations, the platform can declare that successful participant is the winner and can award the winner a reward.

Non-transitory computer program products (i.e., physically embodied computer program products) are also described that store instructions, which when executed one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The current subject matter can provide various advantages. For example, the current subject matter can provide an interactive wagering platform, which can enhance participant/spectator experience. The current subject matter can also provide a gaming experience with financial or other rewards to the winning participant(s).

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIGS. 1-10 illustrate various exemplary implementations in accordance with the current subject matter;

FIG. 11 illustrates an exemplary computer-implemented system, according to some implementations of the current subject matter, and

FIG. 12 illustrates an exemplary method, according to some implementations of the current subject matter.

### DETAILED DESCRIPTION

In some implementations, the current subject matter relates to a wagering platform for an event, such as a sporting or entertainment event, to facilitate, for example, additional enjoyment and participation during the event.

For example, the current subject matter can provide a tournament in a “survivor” league format, whereby participants can pay entry fees (e.g., money or other means) into a contest. In some exemplary implementations, the current subject matter can require contestants to make consecutive winning selections until only one participant (for example) with a perfect record remains. In some exemplary implementations, one or more contestants can be allowed up to a selected number of wrong selections before being eliminated. The contestants can be ranked based on their performance, and the contestant with the best record (e.g., the highest number of correct selections and/or the lowest number of wrong selections) can be determined.

Actions:

As an illustrating (non-limiting) example, the current subject matter can be implemented for a soccer (non-American football) match. In the soccer example, the current subject matter can define one or more actions, such as a (1) Throw-In; (2) Corner Kick; (3) Goal Kick; and (4) Free Kick.

In some implementations, the current subject matter can also be implemented for other sporting events, such as (for example), American Football, Basketball, Baseball, Hockey, and Golf.

In some exemplary implementations, the current subject matter can define one or more actions for each sporting event as follows:
American Football: (1) Punt; (2) Touchdown; (3) Field Goal; (4) Turnover;
Basketball: (1) Made Free Throw; (2) Made Dunk; (3) Made 3-Pointer; (4) Turnover;
Baseball: (1) Single; (2) Double or Triple; (3) Homerun; (4) Walk;
Hockey: (1) Icing; (2) Offside; (3) Penalty; (4) Other Stoppage;
Golf: (1) Birdie or better; (2) Par; (3) Bogey; (4) Double Bogey or worse.

As can be understood by one having ordinary skill in the art, the above examples are provided herein for illustrative, non-limiting purposes. Other variations may include, for example, additional defined actions; other defined actions; and/or various combinations.

Selection Process:

Each participant can be provided with one or more options for how to select an Action:
(1) Manual: Participant manually selects an Action, for example, via a mouse click on a desktop, or by tapping on a smartphone or tablet.
(2) Algorithm/Expert Pick: Participant can be automatically assigned an Action pursuant to, for example, an algorithm designed to maximize value by factoring in likelihood of an Action to occur and the projected pick distribution based on historical data.
(3) Most Popular: Participant can be automatically assigned the Action that is most selected among the other participants.
(4) Least Popular: Participant can be automatically assigned the Action that is least selected among the other participants.

In some exemplary implementations, if no method is selected by the participant, or if the method selected cannot function properly because of the number of participants remaining and/or other selection methods being used (e.g., if only five people remain and they all select “Least Popular”), then the participant can be assigned a default pick, which may be, for example, the last Action that the participant selected, the most-commonly picked Action of the tournament, or simply a pre-designated Action (e.g., Throw-In). The selection process can be, for example, repeated for each trial of a tournament in accordance with the current subject matter.

Timing:

After the Actions are made available to the participants for selection, for example via computers and/or mobile devices, the participants can be given a “Betting Window” to select one of the defined Actions. For example, in some implementations, the Betting Window can be 30 seconds, 40 seconds, and/or any other pre-determined time period. In some implementations, the Betting Window is 30 seconds for basketball. In some implementations, the Betting Window is 40 seconds for soccer.

In some implementations, the Betting Window can be presented via an on-screen timer, with visual cues further indicating how much time is remaining to make a selection (e.g., the timer may originally appear in green, then gradually change color through various shades of orange before turning red as the timer nears 0). After the Betting Window expires, the current subject matter can provide an additional “Run-Off Period” (e.g., 10 seconds, and/or other time-period) during which no more selections will be accepted. The Run-Off Period can also be presented, for example, via an on-screen timer with visual cues indicating how much time is remaining before the selections are officially “live” (e.g., the timer may originally appear in red, then gradually change color through various shades of orange before turning green as the timer nears 0). After the Run-Off Period has expired, the selections can be considered “in play,” and the next Action to occur in the event (e.g., match) can determine who advances to the next trial (or round). Only those Actions that occur after a Run-Off Period but before the next Betting Window (a “Live Event”) can be counted for purposes of determining which participant(s) advance and which ones are eliminated.

Pick Distribution:

In some implementations, as soon as the Betting Window has expired, participants can be presented with a breakdown of the participants' pick distribution among the defined Actions, showing one or more of (for example), the number of participants who selected each of the defined Actions and the corresponding percentage breakdown. This information can indicate precisely how many participants will advance and how many will be eliminated depending on the next Live Action to occur. Participants can (also) be provided, for example, with a continuously updating list of their individual selections (the “Selection History”) for as long as they remain in the contest/tournament.

Exemplary Implementation (Illustrative and Non-Limiting):

100 Participants enter a tournament in accordance with the current subject matter at the beginning of a soccer (non-American football) match. Within the first few seconds of the match, the participants can be presented with a selection screen presenting the four defined Actions from which the participants may choose. An on-screen timer can also count down the Betting Window, after which all selections can be locked in and no additional selections/changes can be made. The Run-Off Period timer can then commence, during which period the participants can be presented with a visual representation of the pick distribution and percentage breakdown of all the participants across the four defined Actions. As soon as the Run-Off Period expires, the next Action that actually occurs in the soccer match can determine who advances to the next round (to select the next Action) and who is eliminated. For example, if the first Action after the Run-Off Period is a throw-in, and 50 of the 100 initial participants selected Throw-In, those 50 can advance to the next round/trial while the others can be eliminated. Those remaining 50 participants can then be presented with a new selection screen, for example, along with their previous pick in their Selection History. The process can repeat one or more times until, for example, there is only one participant (or other defined number) remaining.

Multiple Tournaments:

In some implementations, the Multiple tournaments can be held in a single event (e.g., a single soccer match). For example, after each Live Action occurs in a given trial, the next selection process can function not only as the subsequent trial for that ongoing tournament, but also as the opening trial for a brand new tournament. Accordingly, participants who are knocked out of a tournament can join another tournament almost immediately thereafter (or simultaneously). Additionally, participants who have not been knocked out, but who wish to enter another tournament such that they are active in multiple tournaments simultaneously, can also be permitted to do so.

In some implementations, the participants can (further) be permitted to enter multiple tournaments across multiple events (e.g., multiple soccer matches, or combinations of different sporting events). For example, the soccer matches running tournaments in accordance with the current subject matter can be readily accessible for selection at the top of the screen. To the extent participants are active in multiple tournaments across multiple soccer matches (or other events), the soccer match (or events) requiring a selection can flash (for example, or by other visual cues) to notify the participant that he or she must select (e.g., click or tap) that match and make his or her selection.

Prize(s):

In some implementations, each tournament can offer a prize to the winner, for example, based on the total entry fees paid by all the participants for that tournament less a fixed percentage fee (or other amounts) to be retained by the operator/website hosting the tournament (the “Prize Pool”).

Carryover/Distributions:

In some implementations, it may be possible that a tournament does not result in a single winner. For example, three participants may advance to a tournament's final trial/round, only to have all three be eliminated when no one selects the correct Action (e.g., one selects Throw-In, one selects Goal Kick, and one selects Free Kick, but the next live Action ends up being a Corner Kick). In that case, in some exemplary implementations, a portion (or all) of the Prize Pool can be distributed evenly among those remaining participants who survived to that last trial/round, and the remaining portion of the Prize Pool can be allocated, for example, to a Progressive Jackpot.

Progressive Jackpots:

In some implementations, Progressive Jackpots can be offered to the winners of specially designated tournaments such as those reserved for the most popular/watched events (e.g., the Champions League finals). These specially designated tournaments can be, for example, open only to select participants who have earned sufficient Experience Points (or other qualifications) over the course of, for example, the soccer season.

Experience Points:

In some implementations, Experience Points can be allocated, for example, based on the number of regular tournaments a participant has entered. In some implementations, Experience Points can be used for entry (or multiple entries) into one or more Progressive Jackpot tournaments. In some implementations, Experience Points may (also) be used to gain certain advantages in the Progressive Jackpot tournament(s). For example, with a sufficient number of Experience Points, participants can be granted multiple “lives” in a Progressive Jackpot tournament, such that they are permitted to make a number of wrong selections before being eliminated, and/or make multiple selections in any given Progressive Jackpot tournament trial.

Strikes:

In some implementations, contest participants can be afforded multiple wrong guesses before they are eliminated, such as a “three strikes you're out” rule, where only after three incorrect predictions will a participant be eliminated from the contest. In some variations, contestants will be able to see how many “strikes” each contestant has remaining.

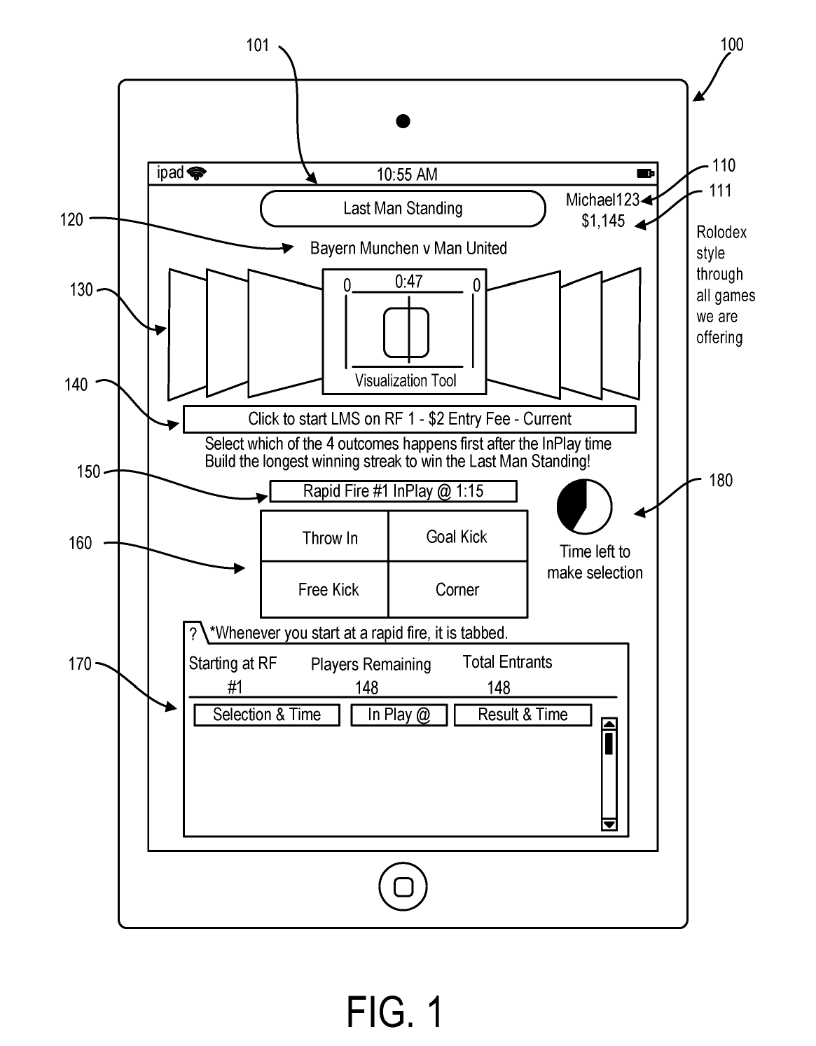

References will now be made to FIGS. 1-10, which illustrate exemplary implementations of the current subject matter. These implementations are non-limiting examples and are provided herein for illustrative and/or ease of discussion purposes only. FIG. 1 illustrates an exemplary graphic display of a wagering platform 100, according to some implementations of the current subject matter. The display can include a user name 110 of the participant (Michael123) and his/her account balance 111 ($1,145). In some implementations, the Experience Points can also be included. The display can also include a tournament name 101 (“Last Man Standing”); a selected event/match 120 (Bayern Munchen v. Man United); a Visualization Tool 130 (showing, for example, a viewing of the match, and the game time); a tournament status 140; an event status 150; defined Actions 160; a history 170; and time-left-to-make selection 180. As shown in FIG. 1, the participant can be provided with an opportunity to join the tournament by paying an entry fee.

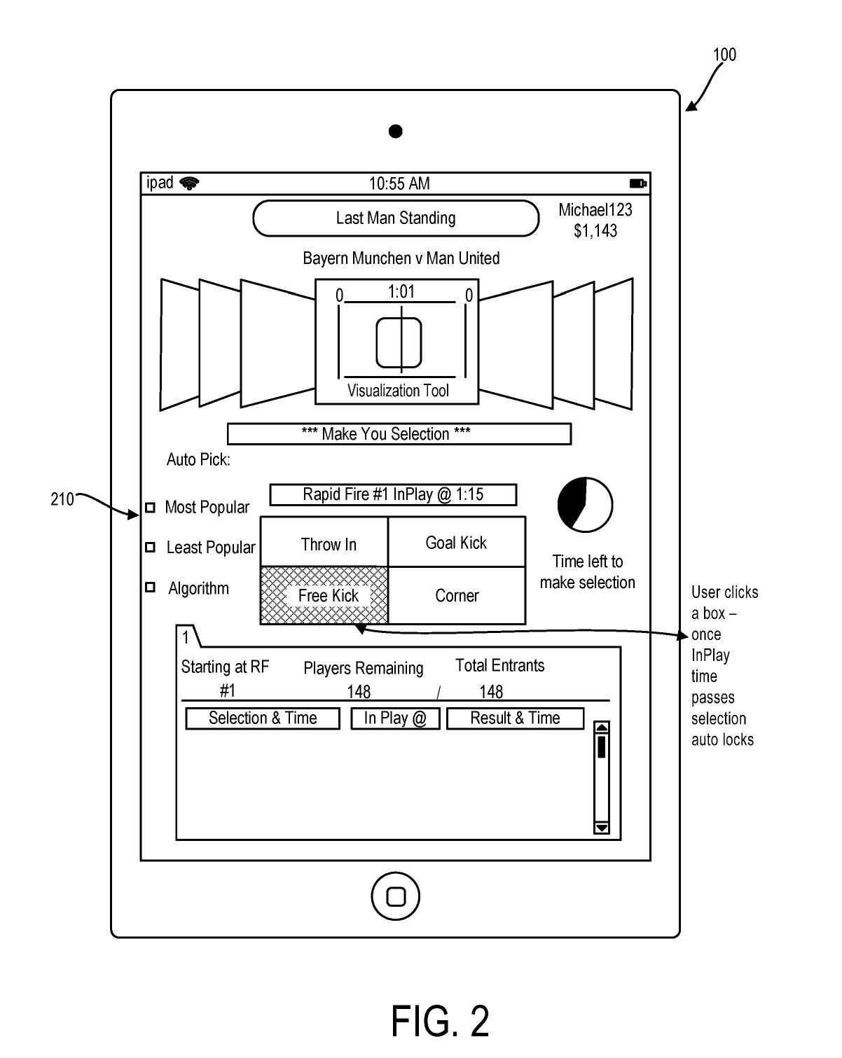

As shown in FIG. 2 (illustrating system 100 shown in FIG. 1), the participant has selected to join the tournament and paid the entry fee, and can now be permitted to select one of the defined Actions. The participant can also be given an opportunity to select one of the “Auto Pick” options 210. Here, the participant selects “Free Kick” as the Action he is predicting.

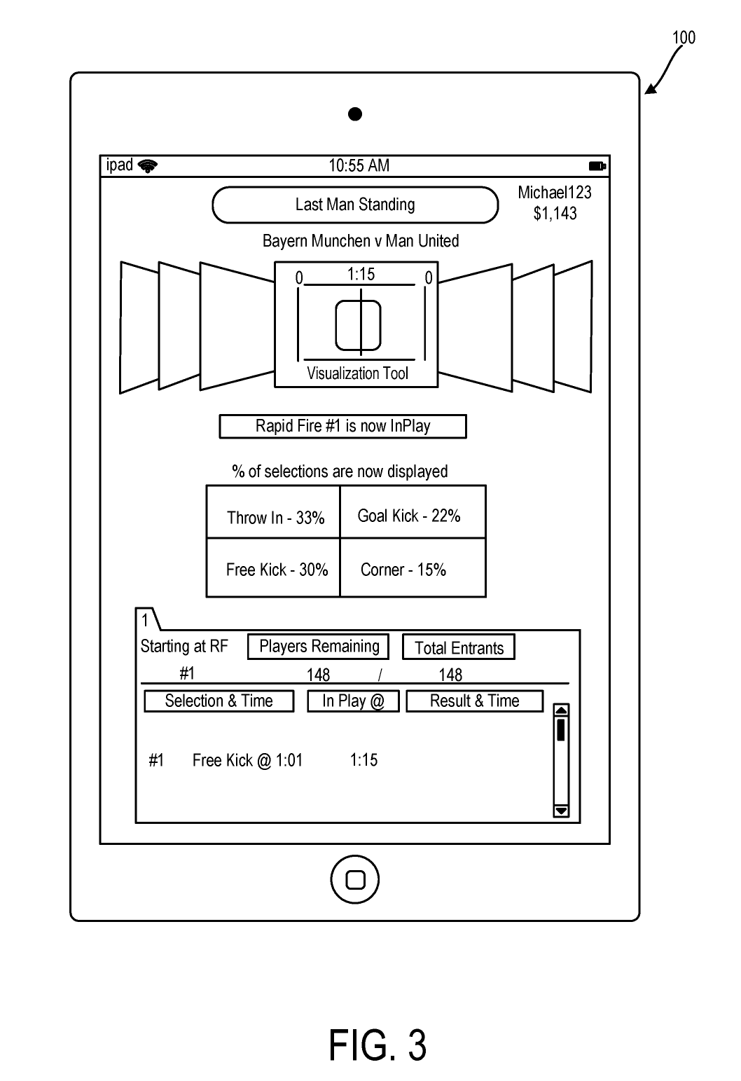

As shown in FIG. 3 (illustrating system 100 shown in FIG. 1), the participant's selection has been locked in, and the display can show that the Rapid Fire #1 is now in play. The Action display 160 can now show a breakdown of the tournament participants' selections.

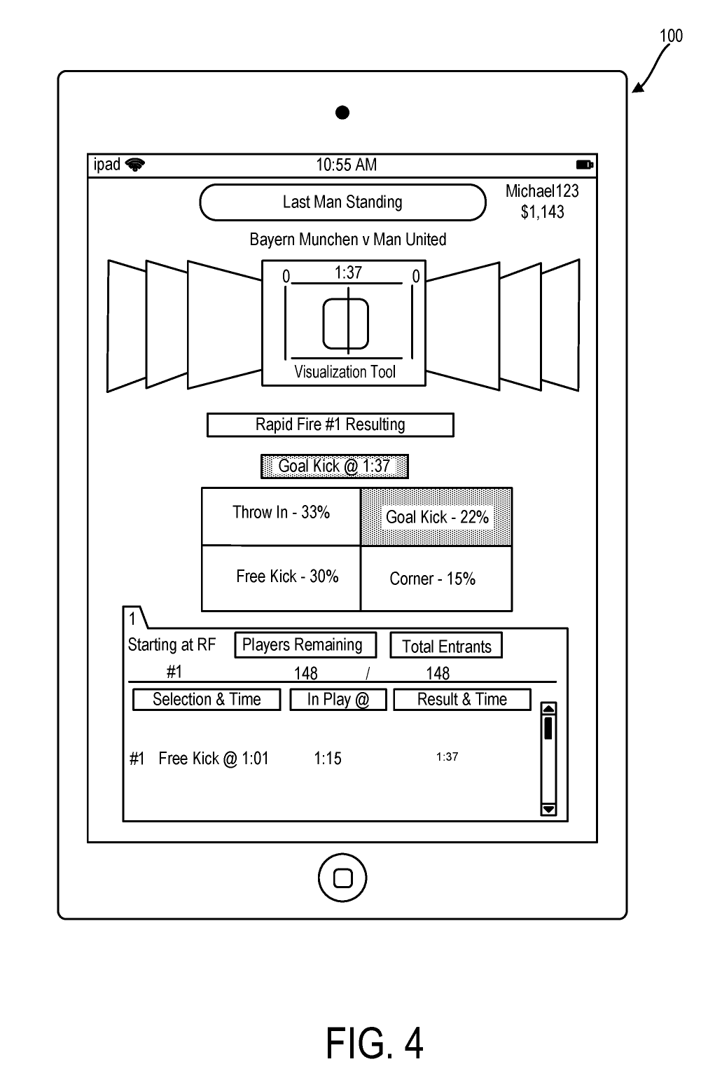

As is further shown in FIG. 4 (illustrating system 100 shown in FIG. 1), unfortunately for the participant, the actual Action that occurred in the match (at 1:37 of match time, which is the first occurrence of one of the defined Actions after the match time 1:15) is a Goal Kick. Accordingly, the participant Michael123's selection of Free Kick was unsuccessful, and he is eliminated from the tournament.

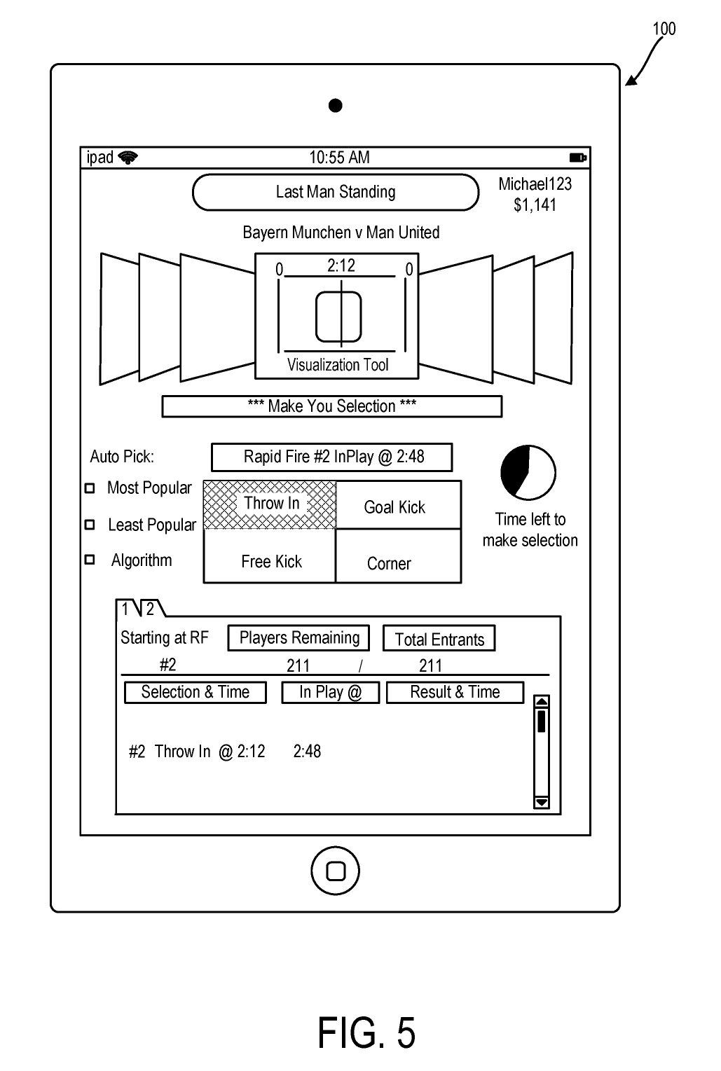

However, as shown in FIG. 5 (illustrating system 100 shown in FIG. 1), Michael123 participates in the next round by paying another entry fee, where he selects “Throw In” to be the next play after match time 2:48.

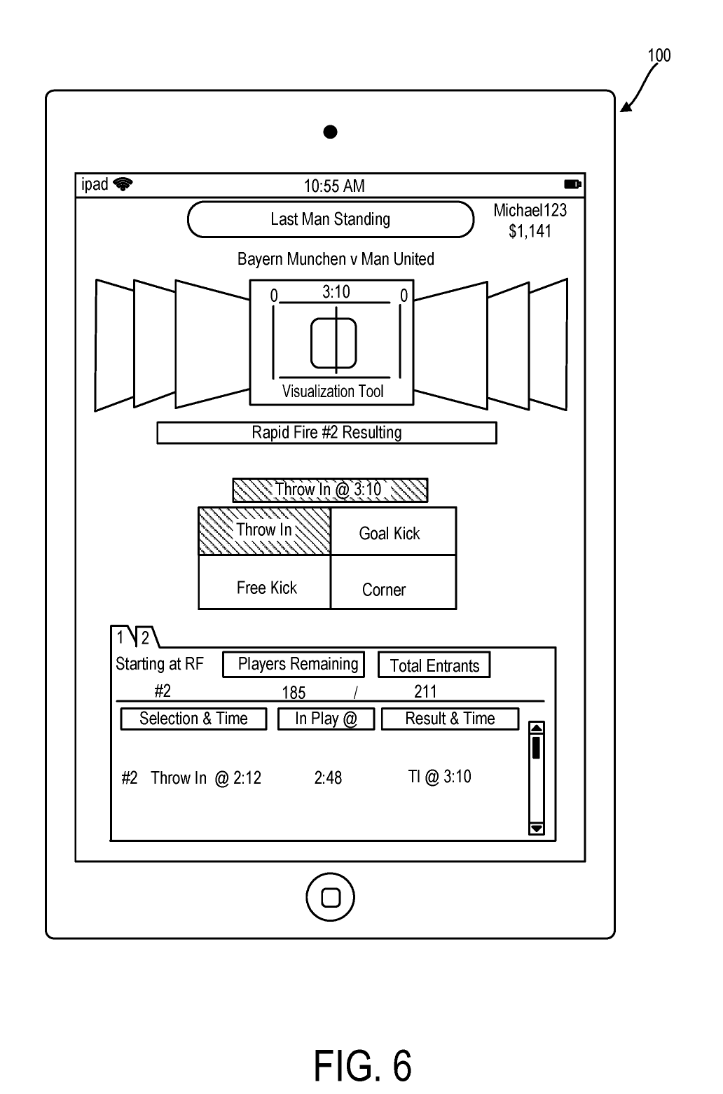

As shown in FIG. 6 (illustrating system 100 shown in FIG. 1), a throw in occurred in the match at 3:10, which was the first of the defined Actions that occurred in the match after time 2:48. Accordingly, the participant can advance to the next trial/round and continues the process.

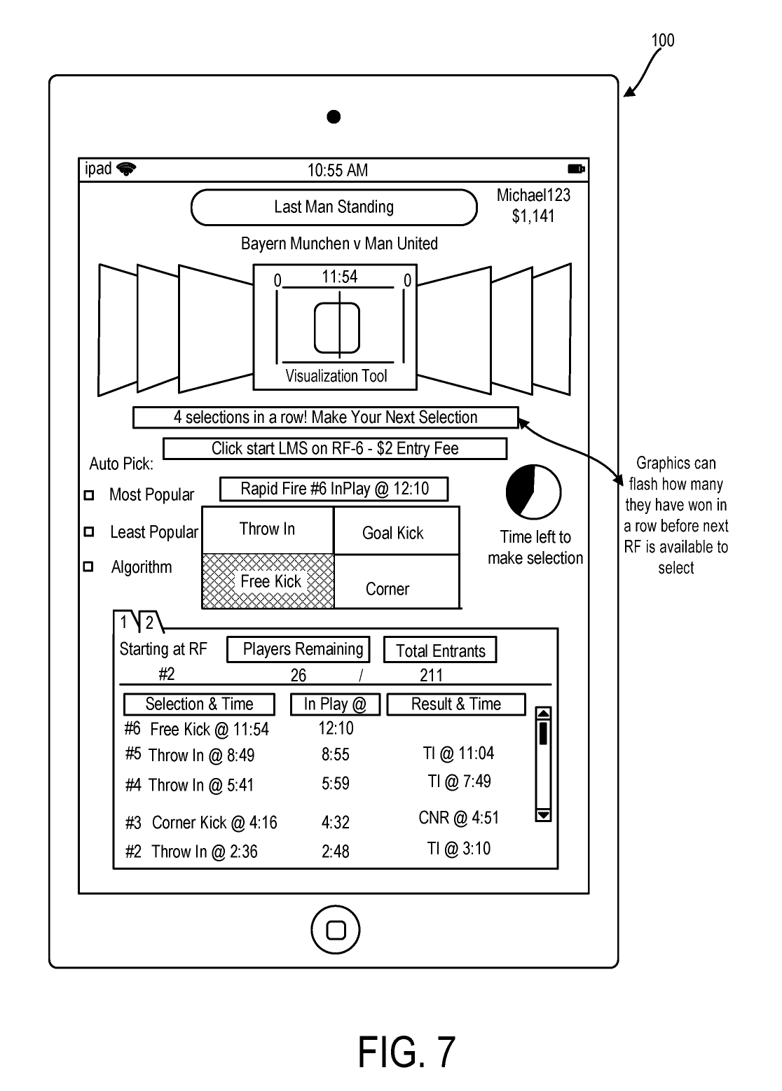

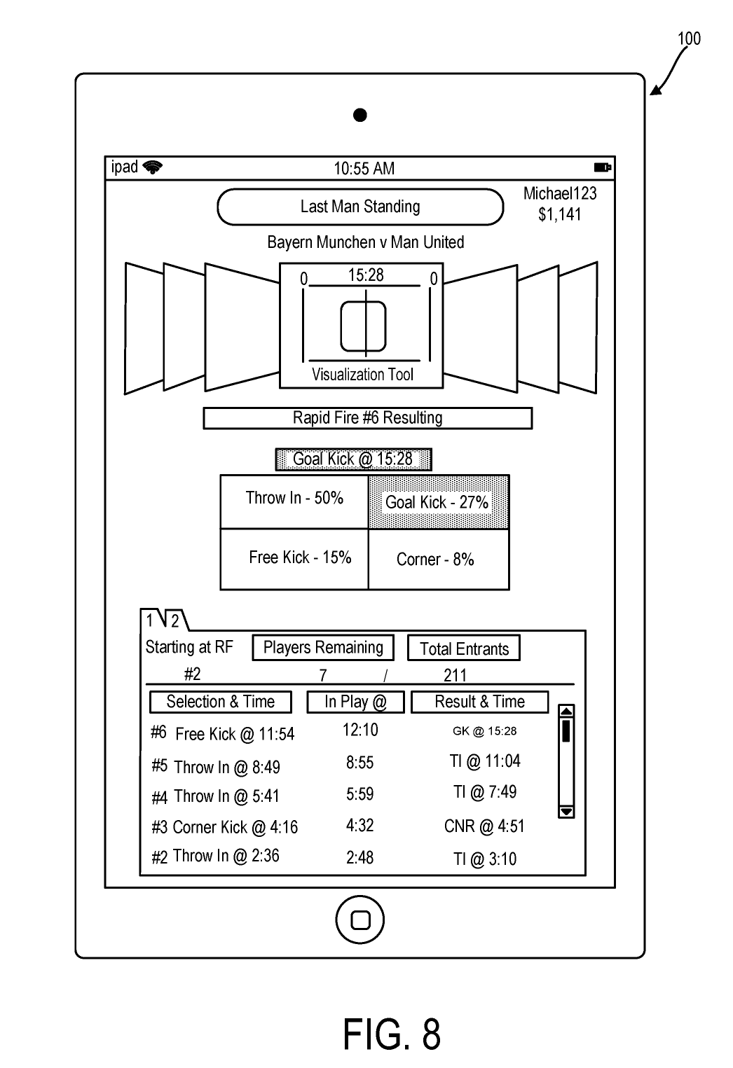

As shown in FIG. 7 (illustrating system 100 shown in FIG. 1), the participant has successfully selected 4 selections in a row. Unfortunately, as shown in FIG. 8 (also illustrating system 100 in FIG. 1), he loses Rapid Fire #6.

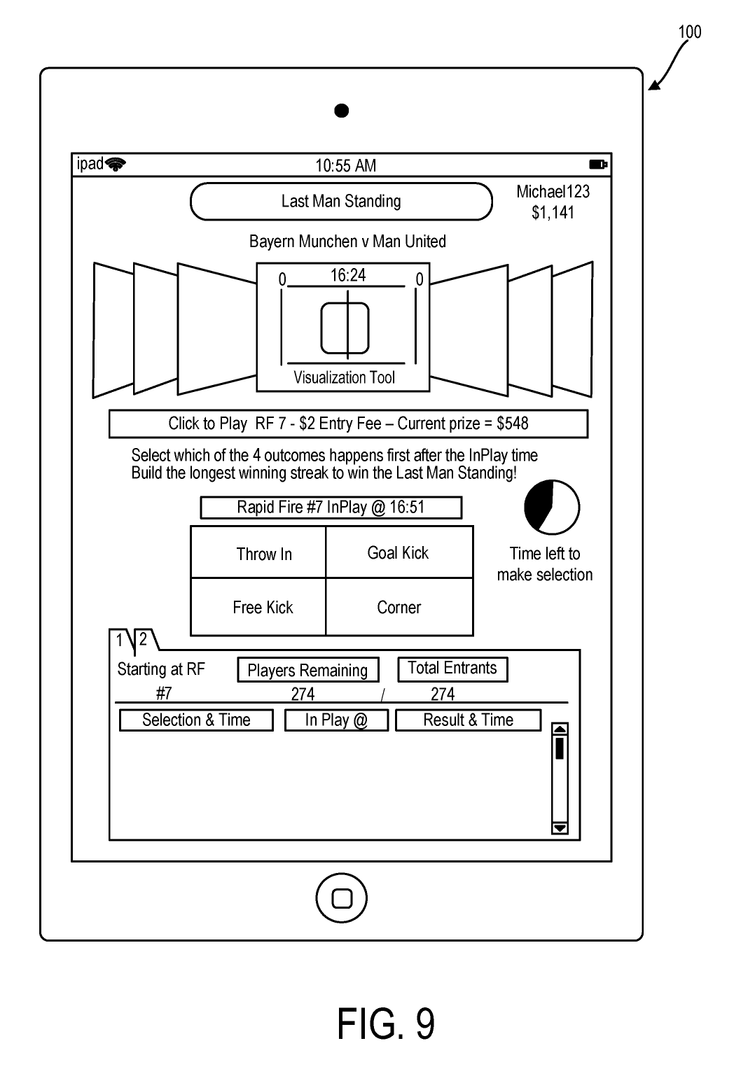

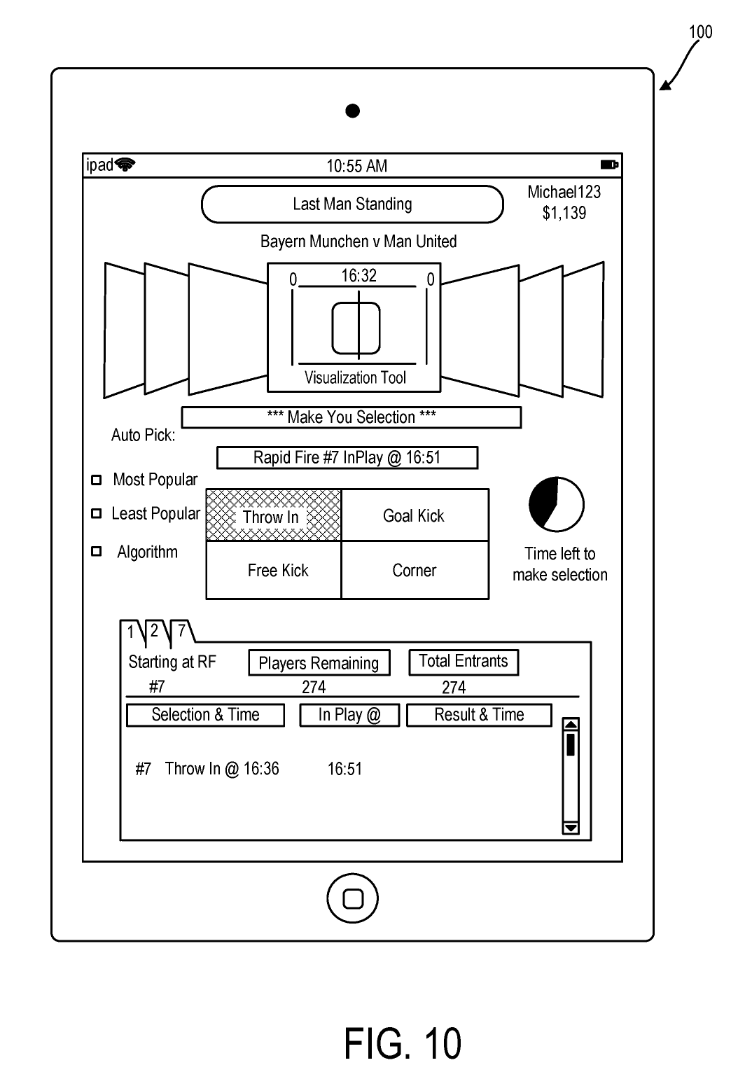

As shown in FIG. 9 (illustrating system 100 shown in FIG. 1), the participant can be given an opportunity to participate in Rapid Fire #7 by paying another entry fee. Here, the display can also show the current prize. FIG. 10 (illustrating system 100 shown in FIG. 1) shows participant's decision to rejoin the tournament and selection of the next event.

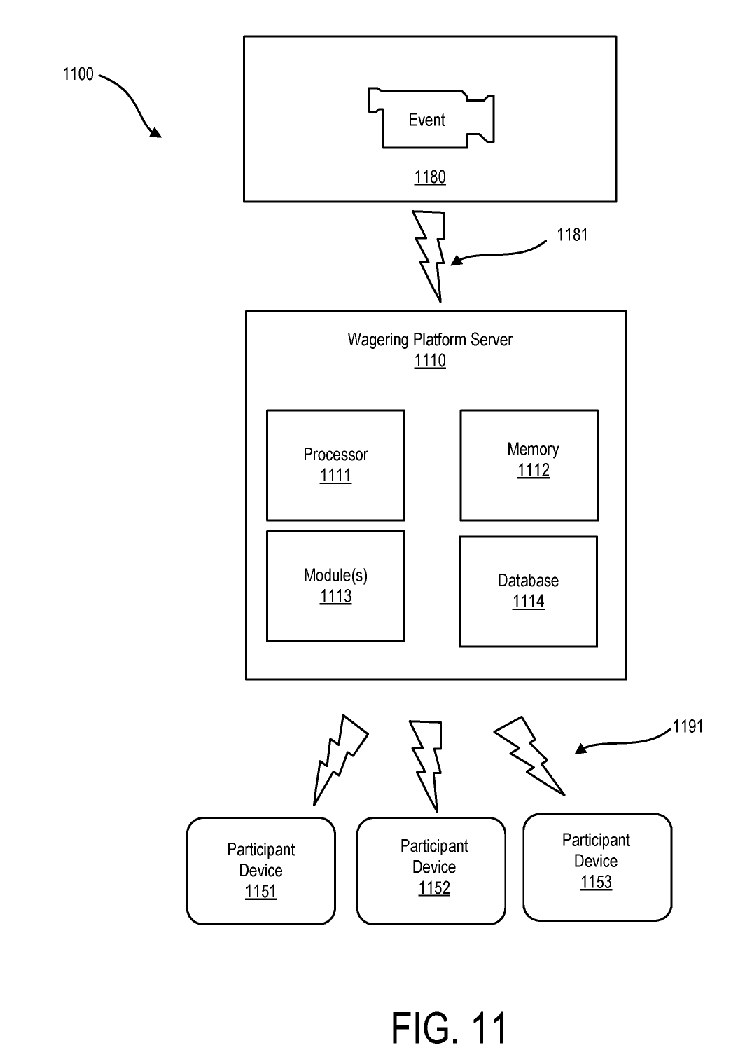

FIG. 11 shows an example of a computer-implemented wagering platform system 1100 in accordance with the current subject matter. This example is being provided for illustrating purposes only and is not intended to limit the current subject matter. The system 1100 can include a live feed from an event 1180 (e.g., a sporting event such as a soccer match, etc.), a Wagering Platform Server 1110, and a plurality of Participant Devices 1151-1153. The live feed of the event 1180 can include, for example, video, audio, text, graphics, alerts, email messages, short-message-service (“SMS”) messages, multi-media-service messages (“MMS”), and/or any other data, and/or any combination thereof, which can be transmitted to the Wagering Platform Server 1110 via, for example, a one-way or two-way communication connection. The Wagering Platform Server 1110 can include one or more processor 1111, memory 1112, module 1113, and/or database 1114 communicatively coupled with one another through various means (e.g., wired, wireless, wireline, etc.) for implementing the wagering platform and perform one or more features discussed herein. The Wagering Platform Server 1110 can also be in communication 1191 with the plurality of Participant Devices 1151-1153 to transmit and/or receive, for example, audio, text, graphics, alerts, email messages, short-message-service (“SMS”) messages, multi-media-service messages (“MMS”), and/or any other data, and/or any combination thereof to and from the Participant Devices. Each of the Participant Devices can also include one or more processors, memories, modules, and/or databases communicatively coupled with one another through various means (e.g., wired, wireless, wireline, etc.) to implement, for example, portions of the wagering platform and perform one of more features discussed herein.

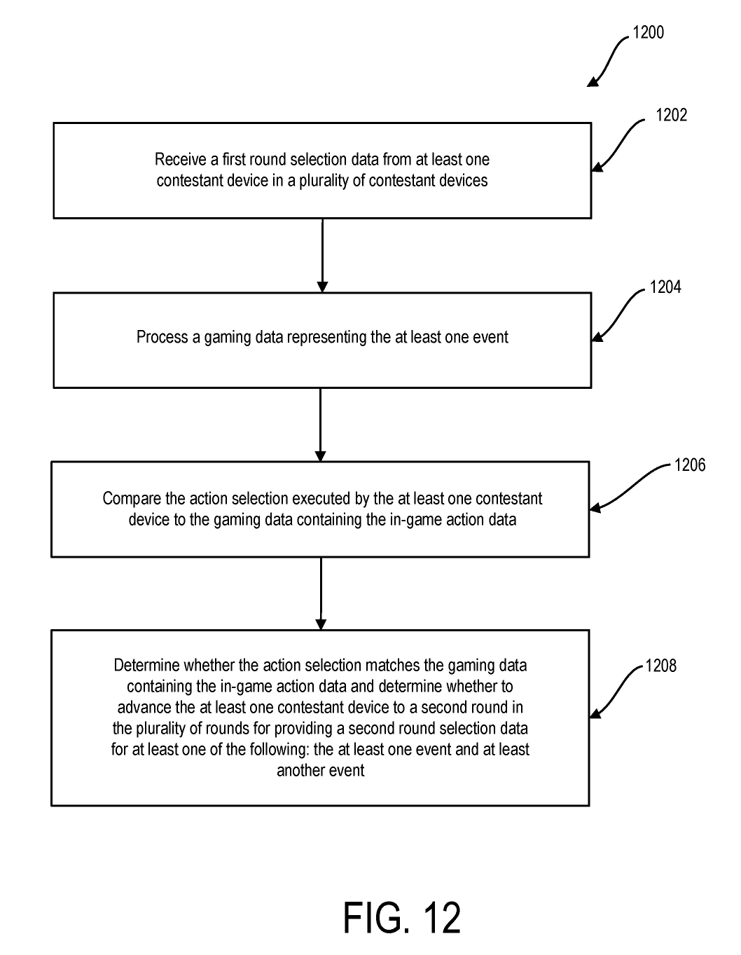

FIG. 12 illustrates an exemplary computer-implemented method 1200 for placing a wager, according to some implementations of the current subject matter. At 1202, a first round selection data can be received from at least one contestant device in a plurality of contestant devices (as such as those shown in FIGS. 1-11). The first round selection data can include an action selection executed by the contestant device for at least one event in a first round in a plurality of rounds. At 1204, a gaming data representing the event can be processed. The gaming data can be received from at least one another device (e.g., television broadcaster, cable broadcaster, website, news media, telephone, text messaging, etc. and/or any combination thereof). The gaming data can include at least one in-game action data. At 1206, the action selection executed by the contestant device can be compared to the gaming data containing in-game action data. At 1208, based on the comparison, a determination can be made whether the action selection matches the gaming data containing in-game action data and determining whether to advance the contestant device to a second round in the plurality of rounds for providing a second round selection data for at least one of the following: the current event and/or at least another event.

In some implementations, the current subject matter can include one or more of the following optional features. The process 1200 can also include declaring at least one winning contestant device in the plurality of devices. The winning device can be the only contestant device remaining in a final round in the plurality of rounds. The final round can include at least one of the following: the first round, the second round and at least one round in the plurality of rounds.

In some implementations, the action selection can be manually executed by the contestant device. The action selection can be executed using an artificial intelligence processor. The artificial intelligence processor can determine a likelihood of an in-game action to occur and a projected selection distribution based on historical data.

In some implementations, the action selection can be automatically executed based on an action selection that is most frequently executed by the plurality of contestant devices. The action selection can be automatically executed based on an action selection that is least frequently executed by the plurality of contestant devices.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed:

1. A computer-implemented method, comprising:
receiving a first round selection data from at least one contestant device in a plurality of contestant devices, the first round selection data including an action selection executed by the at least one contestant device for at least one event in a first round in a plurality of rounds;
processing a gaming data representing the at least one event, the gaming data being received from at least one another device, the gaming data including at least one in-game action data;
comparing the action selection executed by the at least one contestant device to the gaming data containing the in-game action data; and
determining, based on the comparing, whether the action selection matches the gaming data containing the in-game action data and determining whether to advance the at least one contestant device to a second round in the plurality of rounds for providing a second round selection data for at least one of the following: the at least one event and at least another event;
wherein at least one of the receiving, the processing, the comparing, and the determining is performed by at least one processor of at least one computing system.

2. The method according to claim 1, further comprising declaring at least one winning contestant device in the plurality of devices, wherein the at least one winning device is the only contestant device remaining in a final round in the plurality of rounds, the final round including at least one of the following: the first round, the second round and at least one round in the plurality of rounds.

3. The method according to claim 1, wherein the action selection is manually executed by the at least one contestant device.

4. The method according to claim 1, wherein the action selection is executed using an artificial intelligence processor.

5. The method according to claim 4, wherein the artificial intelligence processor determines a likelihood of the in-game action to occur and a projected selection distribution based on historical data.

6. The method according to claim 1, wherein the action selection is automatically executed based on an action selection that is most frequently executed by the plurality of contestant devices.

7. The method according to claim 1, wherein the action selection is automatically executed based on an action selection that is least frequently executed by the plurality of contestant devices.

8. A wagering system, comprising:
at least one memory; and
at least one processor operatively coupled to the memory, the at least one processor being configured to:
receive a first round selection data from at least one contestant device in a plurality of contestant devices, the first round selection data including an action selection executed by the at least one contestant device for at least one event in a first round in a plurality of rounds;
process a gaming data representing the at least one event, the gaming data being received from at least one another device, the gaming data including at least one in-game action data;
compare the action selection executed by the at least one contestant device to the gaming data containing the in-game action data; and
determine, based on the comparison, whether the action selection matches the gaming data containing the in-game action data and determine whether to advance the at least one contestant device to a second round in the plurality of rounds for providing a second round selection data for at least one of the following: the at least one event and at least another event.

9. The system according to claim 8, wherein the operations further comprise declaring at least one winning contestant device in the plurality of device wherein the at least one winning device is the only contestant device remaining in a final round in the plurality of rounds, the final round including at least one of the following: the first round, the second round and at least one round in the plurality of rounds.

10. The system according to claim 8, wherein the action selection is manually executed by the at least one contestant device.

11. The system according to claim 8, wherein the action selection is executed using an artificial intelligence processor.

12. The system according to claim 11, wherein the artificial intelligence processor determines a likelihood of the in-game action to occur and a projected selection distribution based on historical data.

13. The system according to claim 8, wherein the action selection is automatically executed based on an action selection that is most frequently executed by the plurality of contestant devices.

14. The system according to claim 8, wherein the action selection is automatically executed based on an action selection that is least frequently executed by the plurality of contestant devices.

15. A computer program product, for transmission of data packets between a user device and a server, comprising a machine-readable medium storing instructions that, when executed by at least one programmable processor, cause the at least one programmable processor to perform operations comprising:
receive a first round selection data from at least one contestant device in a plurality of contestant devices, the first round selection data including an action selection executed by the at least one contestant device for at least one event in a first round in a plurality of rounds;
process a gaming data representing the at least one event, the gaming data being received from at least one another device, the gaming data including at least one in-game action data;
compare the action selection executed by the at least one contestant device to the gaming data containing in-game action data; and
determine, based on the comparison, whether the action selection matches the gaming data containing in-game action data and determine whether to advance the at least one contestant device to a second round in the plurality of rounds for providing a second round selection data for at least one of the following: the at least one event and at least another event.

16. The computer program product according to claim 15, wherein the operations further comprise declaring at least one winning contestant device in the plurality of devices wherein the at least one winning device is the only contestant device remaining in a final round in the plurality of rounds, the final round including at least one of the following: the first round, the second round and at least one round in the plurality of rounds.

17. The computer program product according to claim 15, wherein the action selection is manually executed by the at least one contestant device.

18. The computer program product according to claim 15, wherein the action selection is executed using an artificial intelligence processor.

19. The computer program product according to claim 18, wherein the artificial intelligence processor determines a likelihood of the in-game action to occur and a projected selection distribution based on historical data.

20. The computer program product according to claim 15, wherein the action selection is automatically executed based on an action selection that is most frequently executed by the plurality of contestant devices.

21. The computer program product according to claim 15, wherein the action selection is automatically executed based on an action selection that is least frequently executed by the plurality of contestant devices.
